(19) United States
(12) Patent Application Publication
(10) Pub. No.: US 2010/0289274 A1
(43) Pub. Date: Nov. 18, 2010

(54) VEHICLE LOCK

(76) Inventor: Gavriel Shafry, Wermelskirchen (DE)

Correspondence Address: CANTOR COLBURN LLP, 20 Church Street, 22nd Floor, Hartford, CT, 06103, US

(21) Appl. No.: 12/779,670

(22) Filed: May 13, 2010

(30) Foreign Application Priority Data
May 14, 2009 (DE) 102009021297.3

(51) Int. Cl. E05C 3/12

(52) U.S. Cl. 292/194

(57) ABSTRACT

A vehicle lock, which is adjustable between an open position, a pre-closing position and a closed position, the vehicle lock having: a pivotally mounted rotary latch configured for movement between an open position, a pre-closing position and a closed position; a locking element that is pivotally mounted about a lock axis for movement between a closed position and an open position, wherein the locking element prevents pivotal movement of the rotary latch when the rotary latch is in the closed position and the locking element is in the closed position and wherein movement of the locking element from the closed position to the open position allows the rotary latch to move from the closed position to the open position and wherein pivotal movement of the locking element from the open position to the closed position moves the rotary latch from the open position to the closed position; an actuator lever that is pivotally mounted about an operating axis for movement between a closed position and an open position, wherein the actuation lever prevents pivotal movement of the locking element when the locking element is in the closed position and the actuation lever is in the closed position and wherein movement of the actuation lever from the closed position to the open position moves the locking element from the closed position to the open position; and a motor configured to move the locking element from the open position to the closed position.

### CROSS REFERENCE TO RELATED APPLICATIONS

This application claims priority under 35 U.S.C. §119 to German Patent Application No. 10 2009 021 297.3 filed May 14, 2009, the contents of which are incorporated herein by reference thereto.

### BACKGROUND

Exemplary embodiments of the present invention relate to a vehicle lock which is adjustable between an open position, a pre-closing position and a closed position.

Such locks are used in particular in doors and other tailgates of vehicles such as hatchbacks, sliding doors or engine hoods.

Essentially an effort is made with both doors and tailgates on vehicles to minimize the force that must be applied by a user or a motorized opening aid to open the door or tailgate. There is now growing demand for upgrading of the seals to the extent that the sealing effects can be improved to reduce wind noise in the interior of the vehicle, for example. This is usually accomplished by a special design of the seals which, results in an increase in the sealing pressure, i.e., the force exerted by the seal on the respective door or tailgate in the closed position is increased. This increase in the sealing pressure in turn results in an increase in the forces that must be overcome when opening the door or tailgate. It follows from this in particular that greater forces are required to close the door or tailgate because it is necessary here to work against the resistance presented by the seal.

In the related art, there have been various approaches with which attempts have already been made to reduce the operating forces required for opening. Furthermore, so-called closing aids have already been proposed, which serve to transfer the door or tailgate, in particular starting from a so-called pre-closing position to the closed position, which corresponds to the completely closed state. The pre-closing position refers to a position of the lock in which the door or tailgate is not yet completely closed but also cannot be opened easily without operating an opening mechanism, but instead is kept in a pre-closed or pre-locked position to a certain extent. The known closing aids are external systems, which are usually connected to the lock by a Bowden cable. Such systems are expensive, complicated and difficult and require a relatively large space for installation in the door or tailgate. Integrated closing aids are essentially known but they always constitute an additional separate system. When such closing aids are combined with motorized opening aids, separate electric motors are necessary for both functions—the opening aid on the one hand and the closing aid on the other hand.

Reference is made in this regard to following patents and patent applications the contents each of which are incorporated herein by reference thereto: DE 103 12 304 A, U.S. Pat. No. 4,203,621, DE 20 2008 012 706 U1, DE 103 27 448 A, WO 2006/087578 A, WO 2008/061 491 A and WO 2007/076 826.

Accordingly, it is desirable to provide a vehicle lock that will combine the above features in simplified, robust and efficient manner.

### SUMMARY OF THE INVENTION

In one exemplary embodiment, a vehicle lock is disclosed. The vehicle lock being adjustable between an open position, a pre-closing position and a closed position and the vehicle lock having: a pivotally mounted rotary latch configured for movement between an open position, a pre-closing position and a closed position; a locking element that is pivotally mounted about a lock axis for movement between a closed position and an open position, wherein the locking element prevents pivotal movement of the rotary latch when the rotary latch is in the closed position and the locking element is in the closed position and wherein movement of the locking element from the closed position to the open position allows the rotary latch to move from the closed position to the open position and wherein pivotal movement of the locking element from the open position to the closed position moves the rotary latch from the open position to the closed position; an actuator lever that is pivotally mounted about an operating axis for movement between a closed position and an open position, wherein the actuation lever prevents pivotal movement of the locking element when the locking element is in the closed position and the actuation lever is in the closed position and wherein movement of the actuation lever from the closed position to the open position moves the locking element from the closed position to the open position; and a motor configured to move the locking element from the open position to the closed position.

Other advantageous embodiments of the invention are also given in the dependent claims, the description and the drawings.

### BRIEF DESCRIPTION OF THE DRAWINGS

Exemplary embodiments of the invention are described in greater detail below with reference to the drawings, in which:

FIG. 1 shows an exemplary embodiment of the invention, where essential components of the lock are shown in a closed position, a pre-closing position and an open position, and

FIG. 2 shows another exemplary embodiment of the invention in a diagram corresponding to that in FIG. 1.

Although the drawings represent varied embodiments and features of the present invention, the drawings are not necessarily to scale and certain features may be exaggerated in order to illustrate and explain exemplary embodiments the present invention. The exemplification set forth herein illustrates several aspects of the invention, in one form, and such exemplification is not to be construed as limiting the scope of the invention in any manner.

### DETAILED DESCRIPTION OF EXEMPLARY EMBODIMENTS

This application claims priority under 35 U.S.C. §119 to German Patent Application No. 10 2009 021 297.3 filed May 14, 2009, attached hereto, the contents of which are incorporated herein by reference thereto.

Exemplary embodiments of the present invention relate to an apparatus and method for providing a latch assembly or vehicle lock. Furthermore, exemplary embodiments are directed to a latch assembly or vehicle lock having a fork bolt or rotary latch movably secured thereto for movement between a latched position or closed position and an unlatched position or open position as well as an intermediary or pre-closing position.

The latch assembly further comprises a locking element that prevents pivotal movement of the rotary latch or fork bolt when the rotary latch is in the closed position and the locking element is in a closed position and wherein movement of the locking element from the closed position to an open position allows the rotary latch or fork bolt to move from the closed position to the open position and wherein pivotal movement of the locking element from the open position to the closed position moves the rotary latch from the open position to the closed position.

In addition, the latch assembly or vehicle lock also comprises an actuation lever that prevents pivotal movement of the locking element when the locking element is in the closed position and the actuation lever is in a closed position and wherein movement of the actuation lever from the closed position to an open position moves the locking element from the closed position to the open position.

In addition and still further the vehicle lock or latch assembly further comprises a motor configured to move the locking element from the open position to the closed position and in another embodiment, the motor is also configured to move the actuation lever from the closed position to move the locking element form closed position.

One non-limiting exemplary embodiment of the invention is to create an automotive door latch that is adjustable between an open position, a pre-closing position and a closed position and which will have a high level of convenience with the simplest possible and most reliable design, simple and inexpensive manufacturability and the lowest possible weight and smallest possible space requirement by providing at least one closing aid, which ensures reliable conversion of the respective door or tailgate to the completely closed position, in particular even when there is a high sealing pressure of the respective door or tailgate.

In one embodiment, the vehicle lock comprises a pivotally mounted rotary latch, a locking mechanism or locking element and a manually or motor-operable actuator lever. The locking mechanism or locking element is pivotable about a lock axis and by means of which the rotary latch is locked in the closed position and which and can be pivoted in an opening direction to release the rotary latch. The actuator lever is designed to lock the locking mechanism or locking element in the closed position and to be pivotable about an operating axis in an opening direction to release the locking mechanism. In one embodiment, the locking mechanism or locking element is also part of a motor closing aid and is designed to use the motor to pivot the rotary latch into the closing direction starting from the pre-closing position and to establish the closed position.

Accordingly, the use of the locking mechanism or locking element or at least parts thereof for a closing function permits a substantial reduction in the manufacturing cost, the weight and the space required for the lock without having to lose the convenience of a motorized closing aid.

In an especially advantageous further embodiment of the invention, a motor of the closing aid, which is connected to the locking mechanism or locking element is also at the same time connected to the operating mechanism to pivot the actuator lever in the opening direction. For both convenience functions, namely as a closing aid on the one hand and an opening aid on the other hand, only a single electric motor is therefore necessary. It is no longer necessary to provide separate systems for these two functions. Thus increased convenience can be implemented without any mentionable concessions in terms of the manufacturing costs, weight or space required.

According to another advantageous embodiment of the invention, it is provided that the arrangement of the rotary latch and the lock element or mechanism is designed to be self-locking in the closed position and/or in the pre-closing position. The degree of self-locking is preferably selected to be very low and/or the arrangement is designed at the limit of the self-locking effect. This is understood to mean that the self-locking effect is designed so that in the respective position, the lock and/or the door or tailgate equipped with the lock is not securely locked. The system is more or less “at the brink.” Furthermore, the concept of designing a mechanism at the limit of the self-locking effect constitutes a clear technical teaching for those skilled in the art. This design of the lock also achieves a compromise which optimizes the functionality of the lock: if the lock were designed without the self-locking effect, the actuator lever would be under a relatively high load which would substantially increase the opening forces for the user or for a motorized opening aid. However, if a high degree of self-locking effect were provided, it would result in a low load on the operating level and thus relatively low opening forces. At the same time, however, comparatively high forces would be necessary for so-called “lifting” of the lock, i.e., to pivot the locking mechanism in the opening direction. The inventive proposal of designing a lock at the limit of the self-locking effect constitutes a migration of the spine, so to speak, which makes high demands of the specific implementation and arrangement of the individual lock components but also ensures that the forces to be applied in opening can be kept very low without impairing the basic reliable functioning of the lock in the sense of improving convenience.

This aspect, i.e., the design of the lock at the limit of the self-locking effect, constitutes an independent exemplary embodiment of the present invention, i.e., this embodiment can also be implemented even without providing a closing aid and/or without the idea of simultaneously providing the locking mechanism as a component of a motorized closing aid.

In another embodiment or alternative embodiment of the present invention, the locking element or locking mechanism may comprise a retaining pawl that can be pivoted about the lock axis, while cooperating directly with the rotary latch and being designed to lock the rotary latch in the locked position as a component of the locking mechanism and also to pivot it and, as a component of the closing aid, to pull it from the pre-closing position into the closed position.

It may be provided here that the locking element or locking mechanism of the vehicle lock has a latching pawl cooperating with the actuator lever.

In another alternative embodiment of the present invention, the locking element or locking mechanism of the vehicle lock comprises a knee lever system, wherein the knee lever system comprises two levers joined together in an articulated joint, a first lever being pivotable about the lock axis, and a second lever being hinged-connected to the rotary latch. Furthermore and in addition, it is possible to provide for the lock to have, in addition to the knee lever system, a latching pawl that cooperates with the actuator lever.

Accordingly embodiments of the invention can be implemented in combination with the variants mentioned above are described herein, wherein the pivotable retaining pawl of the first variant and the knee lever mechanism and/or its first lever pivotable about the lock axis are also referred to in general as the “locking element.”

Thus, according to one exemplary embodiment of the invention, a latching pawl is coupled to a locking element, in particular to the retaining pawl or to the first lever in a rotationally fixed manner with respect to the latching pawl, wherein it is also provided that the latching pawl is pivotable about the lock axis only jointly with the locking element. The latching pawl and the locking element may also be arranged in different planes with respect to the lock axis.

It is also provided that the latching pawl cooperates with the actuator lever in such a way that the latching pawl is blocked by the actuator lever in the closed position and in the pre-closing position.

In addition and in one embodiment, the actuator lever is designed to act upon the locking mechanism or locking element in the opening direction. In particular the actuator lever thus serves not only to release the locking mechanism or locking element, which thus allows pivoting of the rotary latch in the opening direction, but also the actuator lever can actively support the opening process by acting upon the locking mechanism in the opening direction. This action takes place, for example, by driving or pushing a pivotable element of the locking mechanism, in particular a latching pawl of the locking mechanism. This feature also constitutes one exemplary embodiment of the present invention.

In one embodiment, the actuator lever comprises a blocking arm, which is situated on one side of the operating axis and serves to block the blocking mechanism as well as a thrust arm, which is situated on the other side of the operating axis and is designed to pivot the locking mechanism in the opening direction.

It is possible to provide here for the thrust arm to cooperate with a latching pawl of the lock.

According to another exemplary embodiment of the invention, the rotary latch drives the locking mechanism when pivoted in the closing direction. In this way and in particular, in a rapid closing movement such as that which occurs when rapidly closing the door or tailgate, blocking of the lock is prevented, which might otherwise occur in particular due to the fact that a pivotable retaining pawl, which serves to lock the rotary latch in the closed position, does not rotate rapidly enough into the closed position when closing the door or tailgate. In the inventive exemplary embodiment, it is possible to provide for the rotary latch to rotate the retaining pawl in the closing direction when pivoted itself in the closing direction, e.g., to “push it in front of itself” so to speak due to some type of coupling.

It is also possible but not obligatory for the rotary latch, the actuator lever and the locking mechanism or locking element to each be pre-stressed or biased, with a spring or a spring arrangement in particular being provided for this purpose in each case. In particular it is provided that the rotary latch is pre-stressed in the opening direction, the actuator lever is pre-stressed in the locking direction and the locking mechanism or locking element is also pre-stressed in the opening direction.

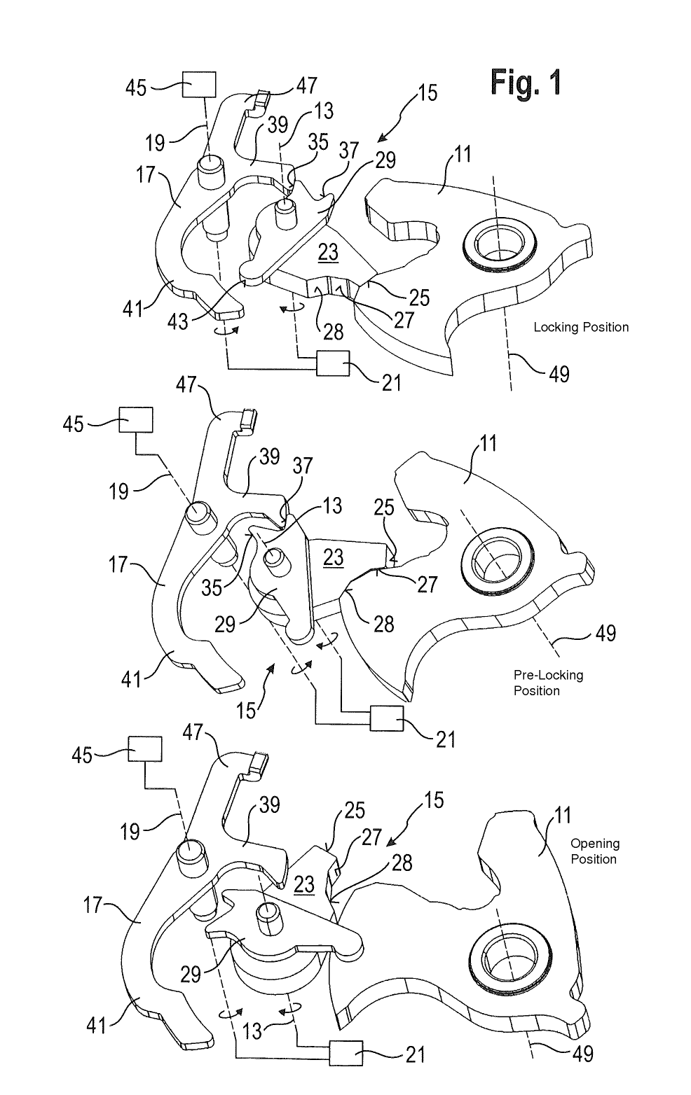

An exemplary embodiment of the present invention is illustrated in FIG. 1 in a closed position, a pre-closing position and an open position. As illustrated, the latch comprises an actuator lever 17, a rotary latch 11 and a locking mechanism or locking element, which in this exemplary embodiment in turn consists of a retaining pawl 23 and a latching pawl 29.

The actuator lever 17 is mounted to pivot about an operating axis 19, whereby the rotary latch 11 is pivotable about a rotary latch axis 49. The retaining pawl 23 and the latching pawl 29 of the locking element are mounted to pivot about a common lock axis 13. The retaining pawl 23 and the latching pawl 29 are arranged in rotationally fixed manner with respect to one another, i.e., the retaining pawl 23 and the latching pawl 29 can only be pivoted jointly. Theoretically the locking element could also be formed by a one-piece component, which may assume the functions of the latching pawl 29 and the retaining pawl 23 which are explained below.

FIG. 1 merely indicates schematically that the actuator lever 17 is coupled to an opening device 45 which comprises in particular an interior opening lever and an exterior opening lever of an automotive door. The coupling mechanism which is provided for this purpose, comprising one or more couplings in particular, is not shown here for the sake of simplicity. Due to the connection of the opening device 45 to the operating axis 19 as shown here, this indicates that the opening device 45 serves to pivot the actuator lever 17 for opening the door or the tailgate about the operating axis 19, namely counterclockwise, as represented by the arrow beneath the actuator lever 17. In a possible embodiment of the lock, the opening device 45 acts on an operating arm 47 in particular and thereby on an angled operating section of the operating arm 47 extending approximately parallel to the operating axis 19.

On one side of the operating axis 19, a blocking arm 39 of the actuator lever 17 is situated, cooperating with the latching pawl 29 in the closed position and in the pre-closing position, namely cooperating with a closing face 35 of the latching pawl 29 in the closed position and cooperating with a pre-closing face 37 of the latching pawl 29 in the pre-closing position. The actuator lever 17 thus serves to prevent pivoting of the locking element about the lock axis 13 in the opening direction by blocking it in both the closed position and in the pre-closing position.

The actuator lever 17 also has a thrust arm 41, which cooperates with a section of the latching pawl 29 having a contact face 43 in opening the lock and/or a door or tailgate equipped with the lock. The thrust arm 41 and the section of the latching pawl 29 having the contact face 43 are coordinated with one another so that when the actuator lever 17 is pivoted in the opening direction of the thrust arm 41, the latching pawl 29 and thus the locking element are pivoted counterclockwise and therefore in the opening direction.

This action on the latching pawl 29 by the thrust arm 41 occurs only when the blocking arm 39 has released the latching pawl 29 by initial rotation of the actuator lever 17 in the opening direction to the extent that the latching pawl can rotate in the opening direction.

The retaining pawl 23 cooperates directly with the rotary latch 11, namely to lock or block the rotary latch 11 and also as a component of a closing aid. In the closed position, the retaining pawl 23 cooperates with a corresponding mating face on the rotary latch 11 via a locking face 25. The retaining pawl 23 is also provided with a pre-closing face 28 by means of which the retaining pawl 23 cooperates with a corresponding mating face of the rotary latch 11 in the pre-closing position. The retaining pawl 23 is also provided with a pre-closing face 28 by means of which the retaining pawl 23 cooperates with a corresponding mating face of the rotary latch 11 in the pre-closing position. Furthermore, the retaining pawl 23 has a closing face 27 which serves to rotate the rotary latch 11 starting from the pre-closing position into the closed position. The lock here is designed so that the arrangement of the rotary latch 11 and the retaining pawl 23 is at the limit of the self-locking effect both in the closed position and in the pre-closing position, i.e., the degree of self-locking effect is selected to be very small as already explained above.

In addition, the inventive vehicle lock comprises an electric motor 21, which is active as a component of an opening aid for opening the door or tailgate and is active as a component of a closing aid in converting the lock from the pre-closing position to the closed position.

The opening function is indicated by connection of the motor 21 to the operating axis 19. The connection between the motor 21 and the lock axis indicates that the motor 21 in its function as a component of the closing aid is able to pivot the locking element clockwise in the direction indicated by the arrow, i.e., in the closing direction around the lock axis 13.

Devices provided for coupling the motor 21 to the actuator lever 17 and the locking element are not shown here although illustrated schematically by the lines connecting motor 21 to the actuator lever 17 and the locking element. Also not illustrated in the figures are sensors and other electric and electronic components which serve to activate and deactivate the motor 21 when the corresponding situation on the lock is detected. For example, a sensor or switch or a plurality of sensors and switches may be located and configured to provide signals to the motor indicative of the state or positions of components of the latch assembly or vehicle lock, which will activate or deactivate the motor which will of course move or stop moving other components of the vehicle lock or latch assembly.

For opening the lock, either an interior opening lever or an exterior opening lever is operated by the user on the opening device 45. This can be detected by means of a sensor system, whereupon the motor 21 is activated to pivot the actuator lever 17 in the opening direction about the operating axis 19. First, this cancels the blocking of the latching pawl 29 by the blocking arm 39 so that the lock element can pivot counterclockwise and thus in the opening direction. The self-locking effect which is in effect in the closed position between the rotary latch 11 and the retaining pawl 23 ensures that the load applied to the blocking arm 39 via the latching pawl 29 is comparatively low so that the force required for the initial pivoting of the actuator lever 17 for the purpose of releasing the locking element is relatively small.

After the latching pawl 29 has been released, the actuator lever 17 acts on the contact face 43 of the latching pawl 29 as the actuator lever is pivoted further by means of its thrust arm 41, so that the latching pawl 29 and the retaining pawl 23 are pivoted as a unit counterclockwise in the opening direction, overcoming the self-locking force between the rotary latch 11 and the retaining pawl 23, which is designed to be small. In this way the retaining pawl 23 releases the rotary latch 11, which can subsequently pivot about the rotary latch axis 49 so that the lock enters the open position.

In closing the lock, the rotary latch 11 is pivoted about the rotary latch axis 49 by means of the locking bar, which is fixedly mounted on the vehicle, in the closing direction, i.e., counterclockwise, until it reaches the pre-closing position. The rotary movements of the rotary latch 11 and the retaining pawl 23 are thus coordinated with one another so that in the pre-closing position the latching pawl 23 is in contact with the rotary latch 11 in the manner illustrated here.

This state is recognized by means of a sensor system that detects the position of the appropriate components and sends a signal or signals to the motor, whereupon the motor 21 is activated and in turn rotates the locking element actively about the lock axis 13 and thus rotates it clockwise in the closing direction. In doing so, the retaining pawl 23 entrains the rotary latch 11 via its closing face 27 and the rotary latch is thus rotated into the closed position with motor assistance, thereby establishing the closed position and completely closing the lock.

It should also be pointed out that in the pre-closing position, the self-locking effect between the rotary latch 11 and the retaining pawl 23, which is designed to be low in the pre-closing position, is in effect, namely acting here on the rotary latch 11 via the pre-closing face 28 of the retaining pawl 23 and the corresponding mating face. This self-locking effect is especially important when, starting from the pre-locking position the lock is to be operated further in the sense of opening it. Depending on the situation in the initial opening, starting from the closed position, the self-locking effect which occurs in the pre-closing position ensures that the load applied to the blocking arm 39 of the actuator lever 17 will be comparatively small, so that only relatively minor forces are required to rotate the actuator lever 17 further in the opening direction, starting from the pre-closing direction, and thus release the latching pawl 29.

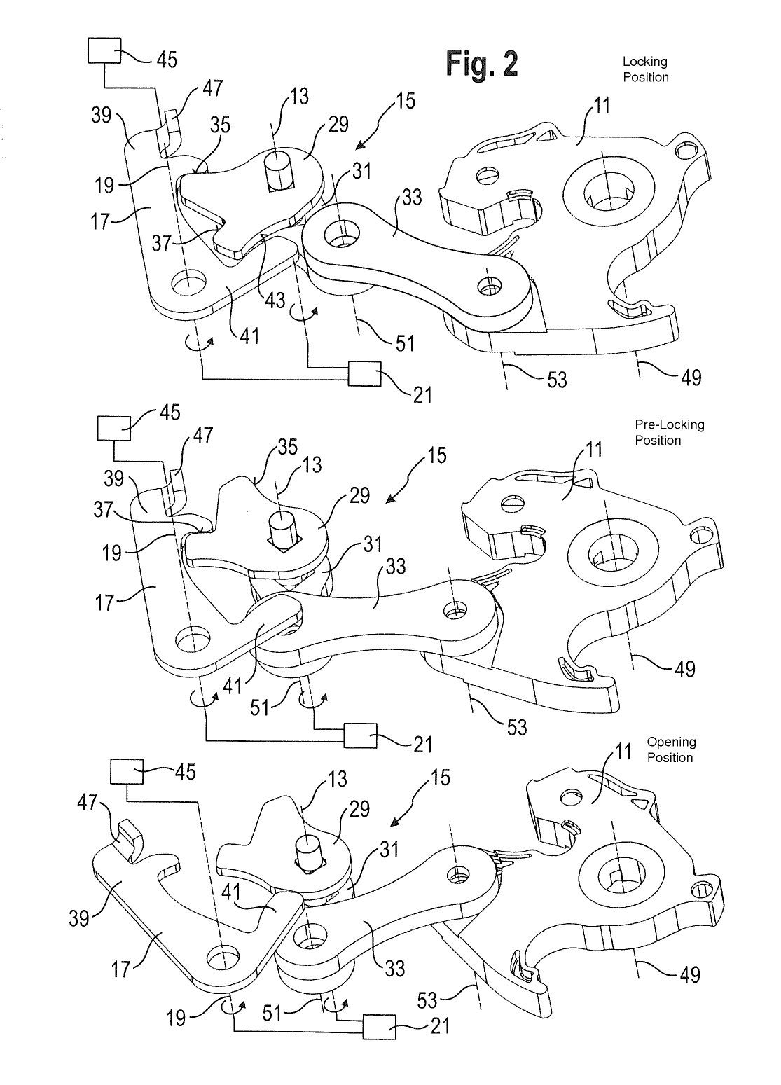

In the exemplary embodiment in FIG. 2, the locking element again comprises a latching pawl 29, which cooperates with the actuator lever 17. Instead of a retaining pawl 23, such as that provided in the exemplary embodiment in FIG. 1, the locking element in the exemplary embodiment in FIG. 2 comprises a knee lever arrangement, which has a first lever 31 and a second lever 33. The two levers 31 and 33 are joined together in an articulated manner, namely so they are pivotable with respect to one another about a common axis 51. At its other end, the first lever 31 is coupled to the latching pawl 29 in a rotationally fixed manner with respect to the lock axis 13, i.e., it can pivot about the lock axis 13 only jointly with the latching pawl 29. The second lever 33 is connected at its other end to the rotary latch 11 in an articulated joint, i.e., it can pivot about another axis 53 relative to the rotary latch 11.

With regard to the basic design, the lock according to FIG. 2 thus otherwise corresponds to the lock according to FIG. 1, so that reference is made to the corresponding statements about FIG. 1 to this extent.

The lock according to FIG. 2 is in turn designed so that in the closed position, the arrangement of the rotary latch 11 and the knee lever arrangement 31, 33 is designed at the limit of the self-locking effect. The forces required to release the latching pawl 29 by pivoting the actuator lever 17 in the opening direction are thus comparatively low.

After the latching pawl 29 has been released, i.e., the closing of the latching pawl 29 has disengaged from the blocking arm 39 of the actuator lever 17, the actuator lever 17 with its thrust arm 41 drives the latching pawl 29 and thus the locking element in the opening direction, such that here there is a pivoting of the latching pawl 29 clockwise about the lock axis 13.

In this way the knee lever arrangement reaches a position which allows pivoting of the rotary latch 11 in the opening direction, i.e., clockwise.

In closing the door or tailgate equipped with the lock, the lock first goes into the pre-locking position. This state is detected, whereupon the motor 21 pivots the arrangement, consisting of the first lever 31 and the latching pawl 29 which are coupled together in a rotationally fixed manner, in the closing direction, i.e., counterclockwise here, about the lock axis 13. In this way, the rotary latch 11 is acted upon, i.e., driven by means of the second lever 33 of the knee lever arrangement, so that it is pivoted counterclockwise in the closing direction around the rotary latch axis 49 with motor assistance until reaching the closed position so that the door or tailgate is completely closed.

FIGS. 1 and 2 also show that with regard to the respective axes, the respective components are not arranged in the same plane. Instead, the corresponding components are arranged in different planes with respect to the different axes, i.e., in particular one above the other. This makes it possible for components of the lock to overlap one another during adjustment, so that on the whole, this achieves a reduction in the space required for the inventive lock.

As used herein, the terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. In addition, it is noted that the terms “bottom” and “top” are used herein, unless otherwise noted, merely for convenience of description, and are not limited to any one position or spatial orientation.

The modifier “about” used in connection with a quantity is inclusive of the stated value and has the meaning dictated by the context (e.g., includes the degree of error associated with measurement of the particular quantity).

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A vehicle lock, which is adjustable between an open position, a pre-closing position and a closed position, comprising:
a pivotally mounted rotary latch configured for movement between an open position, a pre-closing position and a closed position;
a locking element that is pivotally mounted about a lock axis for movement between a closed position and an open position, wherein the locking element prevents pivotal movement of the rotary latch when the rotary latch is in the closed position and the locking element is in the closed position and wherein movement of the locking element from the closed position to the open position allows the rotary latch to move from the closed position to the open position and wherein pivotal movement of the locking element from the open position to the closed position moves the rotary latch from the open position to the closed position;
an actuator lever that is pivotally mounted about an operating axis for movement between a closed position and an open position, wherein the actuation lever prevents pivotal movement of the locking element when the locking element is in the closed position and the actuation lever is in the closed position and wherein movement of the actuation lever from the closed position to the open position moves the locking element from the closed position to the open position; and
a motor configured to move the locking element from the open position to the closed position.

2. The vehicle lock as claim 1, wherein the motor is also configured to move the actuator lever from the closed position to the open position.

3. The vehicle lock as claim 2, wherein movement of the locking element from the open position to the closed position is in a first rotational direction and movement of the actuation lever from the closed position to the open position is in a second rotational direction, wherein the first rotational direction is opposite to the second rotational direction.

4. The vehicle lock as in claim 1, wherein the rotary latch and the locking element are configured to be self locking when the rotary latch is in the closed position or the pre-closing position and wherein the rotary latch and the locking element are configured such that a minimal amount of force is required to unlock the rotary latch and the locking element.

5. The vehicle lock as in claim 1, wherein the locking element further comprises a retaining pawl pivotable about the lock axis and is configured to contact and lock the rotary latch in the closed position when the locking element is in the closed position and wherein the retaining pawl is further configured to move the rotary latch from the pre-closing position to the closed position when the locking element is moved from a pre-closing position to a closed position, the pre-closing position of the locking element being intermediate to the closed position and the open position of the locking element.

6. The vehicle lock as in claim 5, wherein the retaining pawl has two faces spaced a distance apart by the lock axis in a circumferential direction, one of the locking faces being configured for engaging and locking the rotary latch in the closed position and the other one of the two faces being configured to have a cam surface for pivoting the rotary latch into the closed position.

7. The vehicle lock as in claim 5, wherein the locking element further comprises a latching pawl configured to engage the actuator lever.

8. The vehicle lock as in claim 1, wherein the locking element further comprises a knee lever system.

9. The vehicle lock as in claim 8, wherein the knee lever system has a first lever and a second lever joined together in an articulating manner, the first lever being pivotable about the lock axis and the second lever being pivotally connected to the rotary latch and the first lever to provide an articulated joint between the rotary latch and the locking element.

10. The vehicle lock as in claim 9, wherein the locking element further comprises a latching pawl configured to engage the actuator lever.

11. The vehicle lock as in claim 7, wherein the latching pawl is coupled to a the retaining pawl in a rotationally fixed manner with respect to the lock axis and wherein the latching pawl is pivotable about the lock axis only jointly with the retaining pawl.

12. The vehicle lock as in claim 11, wherein the latching pawl and the retaining pawl are arranged in different planes with respect to the lock axis.

13. The vehicle lock as in claim 12, wherein the latching pawl is configured to engage the actuator lever in such a way that the latching pawl is prevented from moving when the locking element is in the closed position or in the pre-closing position.

14. The vehicle lock as in claim 13, wherein the latching pawl has two faces spaced a distance apart from each other in a circumferential direction about the lock axis, one of the faces being a closing face that is configured to cooperate with the actuator lever when it is in the closed position and the other one of the faces being a pre-closing face that is configured to cooperates with the actuator lever when it is in a pre-closing position, the pre-closing position being intermediate the closed position and the open position.

15. The vehicle lock as in claim 3, wherein the actuator lever further comprises a locking arm that is situated on one side of the operating axis and is configured to block movement of the locking element in the first rotational direction and wherein the actuator lever further comprises a thrust arm that is situated on another side of the operating axis and is configured to pivot the locking mechanism in the first rotational direction.

16. The vehicle lock as in claim 7, wherein movement of the locking element from the open position to the closed position is in a first rotational direction and movement of the actuation lever from the closed position to the open position is in a second rotational direction, wherein the first rotational direction is opposite to the second rotational direction and wherein the actuator lever further comprises a locking arm that is situated on one side of the operating axis and is configured to block movement of the locking element in the first rotational direction and wherein the actuator lever further comprises a thrust arm that is situated on another side of the operating axis and is configured to pivot the locking mechanism in the first rotational direction and wherein the thrust arm is configured to engage the latching pawl.

17. The vehicle lock as in claim 16, wherein the latching pawl has a thrust face that is configured to engage the actuator lever and wherein the thrust face is spaced a distance from a closing face and a pre-closing face of the latching pawl, the closing face and the pre-closing face being spaced from each other about the lock axis in a circumferential direction.

18. The vehicle lock as in claim 7, wherein the actuator lever the latching pawl are arranged in the same plane.

19. The vehicle lock as in claim 5, wherein retaining pawl and the rotary latch are arranged in the same plane.
